(19) United States
(12) Patent Application Publication
(10) Pub. No.: US 2014/0195303 A1
(43) Pub. Date: Jul. 10, 2014

(54) METHOD OF AUTOMATED GROUP IDENTIFICATION BASED ON SOCIAL AND BEHAVIORAL INFORMATION

(71) Applicant: Y13 LTD, London (GB)

(72) Inventors: Steve Jarrett, Berkeley, CA (US); Russell Bulmer, London (GB)

(73) Assignee: Y13 Ltd, London (GB)

(21) Appl. No.: 13/789,777

(22) Filed: Mar. 8, 2013

Related U.S. Application Data
(60) Provisional application No. 61/749,674, filed on Jan. 7, 2013.

(51) Int. Cl. G06Q 30/02

(52) U.S. Cl. CPC G06Q 30/0204
USPC 705/7.33

(57) ABSTRACT

A computerized system and method of providing targeting metrics is provided in which a computer performs the steps of: providing a plurality of assigned groups; receiving information sufficient to categorize a plurality of individuals into the plurality of assigned groups; and receiving demographic, social, interest and behavioral information regarding the plurality of individuals. The computer analyzes the demographic, social, interest and behavioral information about the individuals in each of the plurality of assigned groups, and for each assigned group, extracts from the demographic, social, interest, and behavioral information common traits and behaviors of the individuals in said each assigned group. For each group, the computer determines targeting metrics based on the common traits and behaviors identified for said each assigned group.

This application claims priority to U.S. Provisional Application Ser. No. 61/749,674 filed on Jan. 7, 2013, entitled A Method of Automated Group Identification Based on Social and Behavioral Information, the entire disclosure of which is hereby incorporated by reference.

### FIELD OF THE INVENTION

The present invention relates to the data processing of information about people and their social behaviors extracted from online social media and social media sites.

### BACKGROUND INFORMATION

Marketing and advertising regularly use the concept of categorizing people into groups, and targeting those groups in different ways based on demographics and perceived behaviors.

Gathering demographic information about people has been a largely manual process, and determining their behaviors, likes and interests has only been possibly within the domain of an individual businesses activities.

To gather information about people's behaviors, like and interests outside of businesses domain, businesses have resorted to forms and surveys.

Unfortunately the information gathered via these methods is often not accurate, with people not answering questions in a way that indicates how they would like to be perceived, rather than how they honestly behave or value things.

Social media has become increasingly popular way for large numbers of users to interact with one another over the internet. Through social media software applications, large numbers of users can express and share information and opinions with other users. Examples of social media include, for example, wiki sites such as Wikipedia, blogs such as Twitter, social networks such as Facebook™, LinkedIn™, and MySpace™, as well as gaming software such a World of Warcraft™ and Second Life™, online discussion forums, as well as online reviews on e-commerce sites.

A large amount of data is generated by social media. As an example, social networks such as Facebook™ or LinkedIn™ allow users to create individual profiles and web pages. Each profile or web page can include text, images, and/or video, and can identify friends, business contacts, and favorite organizations, websites, or businesses. The profile or web page may also include links to articles or posts on other websites, as well as comments or opinions of the user and the user's friends and business contacts.

It is known that social media can be accessed to generate data regarding products and services and used in targeted advertising to influence purchasing decisions. Social media can also be accessed for other purposes, such as generating demographic information. Accordingly, the rise of social media of social media networks (for example, Facebook™, LinkedIn™, Bebo™, etc.) not only gives businesses access to a person's demographic information, but has created a wealth of information about people's interests and behaviors (for example: online news articles read, rating of friends' activities, “checking-in” at locations, listening to specific music tracks, supporting a specific sports team, etc.).

For example, U.S. Pat. No. 8,312,056 purports to describe a method for identifying a key influencer from social media data which can be used in Enterprise Marketing Services (EMS) to deliver personalized content to a broad customer base in accordance with particular user profile information to improve the response rate to advertisements.

U.S. Pat. No. 8,255,392 purports to describe a real time demographic or population data collection method in which various social networks are accessed, and data from these sources mined and consolidated into a common usable format. The data is sorted and aggregated for a geographic location, then weighted from first, second and third data sets based on the age of the data. A customer is provided with the real time interactive report including demographic data within the specified geographic location. The demographic data includes a confidence interval indicating the degree of likelihood that the demographic data is correct. The first data set can be census data and the second data set can be social media data from social media networks.

United States Patent Publication 2012/0047219 A1, purports to describe systems and methods to collect, analyze and report social media aggregated from a plurality of social media websites. Social media is retrieved from social media websites, analyzed for sentiment, and categorized by topic and user demographics. The data is then archived in a data warehouse and various interfaces are provided to query and generate reports on the archived data. In some embodiments, the system purportedly recognizes alert conditions and sends alerts to interested users. In some embodiments, the system purportedly further recognizes situations where users can be influenced to view a company or its products in a more favorable light, and automatically posts responsive social media to one or more social media websites.

Other systems utilizing social media are described, for example, in U.S. Pat. No. 8,352,406, entitled “Methods and systems for predicting job seeking behavior,” U.S. Pat. No. 8,346,896, entitled “User pivot navigation of shared social media,” U.S. Pat. No. 8,291,016, entitled “System and method of social commerce analytics for social networking data and related transactional data”, U.S. Pat. No. 8,244,664, entitled “Estimating influence of subjects based on a subject graph”, and U.S. Pat. No. 7,974,983, entitled “Website network and advertisement analysis using analytic measurement of online social media content.”

### BRIEF SUMMARY OF THE INVENTION

Marketing and advertising professionals attempt to use as much information form social networks as possible to help guide their classification of people, but this is often an open-ended procedure with no checks or balances to ensure that reality meets with their expectations.

In accordance with an embodiment of the present invention, a computerized system and method of providing targeting metrics is provided in which a computer performs the steps of: providing a plurality of assigned groups; receiving information sufficient to categorize a plurality of individuals into the plurality of assigned groups; and receiving demographic, social, interest and behavioral information regarding the plurality of individuals. The computer analyzes the demographic, social, interest and behavioral information about the individuals in each of the plurality of assigned groups, and for each assigned group, extracts from the demographic, social, interest, and behavioral information common traits and behaviors of the individuals in said each assigned group. For each group, the computer determines targeting metrics based on the common traits and behaviors identified for said each assigned group.

In accordance with further aspects of this embodiment, the computer may also perform the steps of receiving demographic social, interest and behavioral information regarding a plurality of additional individuals; and automatically categorizing the additional individuals into a plurality of categorization groups based on the demographic, social, interest and behavioral information of the additional individuals and the common traits and behaviors identified for said each assigned group.

In accordance with other aspects of this embodiment, the computer may also perform the steps of receiving updated demographic social, interest and behavioral information regarding at least a subset of the plurality of additional individuals; and automatically re-categorizing the at least a subset of the additional individuals into the plurality of categorization groups based on the updated demographic, social, interest and behavioral information of the at least a subset of the additional individuals and the common traits and behaviors identified for said each assigned group, wherein said re-categorizing results in at least some of the subset of individuals changing categorization groups.

In accordance with still other aspects of this embodiment, the computer may also perform the step of, for each of the additional individuals for which the step of re-categorization resulted in a change in categorization group, automatically categorizing said each additional individual into a movement group. In this regard, there may be a plurality of movement groups, and each additional individual for which re-categorization resulted in a change in categorization group may be categorized into at least one of the plurality of movement groups. The plurality of movement groups may, for example, include a separate movement group for individuals who have moved from one categorization group to another categorization group; and/or a separate movement group for individuals who have moved from categorization group X to categorization group Y; and/or a separate movement group for individuals who have moved from one categorization group to another categorization group and back.

In accordance with still other aspects of this embodiment, the computer may also perform the step of generating a plurality of meta groups, each meta group being a combination of assigned groups, or a combination of categorization groups, or a combination of one or more assigned groups and one or more categorization groups.

In accordance with still other aspects of this embodiment, the computer may also perform the step of transmitting the targeting metrics to an on-line advertising system.

In accordance with still other aspects of this embodiment, the computer may also perform the step of using the on-line advertising system, transmitting advertisements to internet users based upon the assigned groups and the common traits and behaviors of the assigned groups.

In accordance with still other aspects of this embodiment, the computer may also perform the step of, using the on-line advertising system, transmitting advertisements to internet users based upon the assigned groups, the categorization groups, and the common traits and behaviors of the assigned groups, and the common traits and behaviors of the categorization groups.

In accordance with still other aspects of this embodiment, the computer may also perform the step of, using the on-line advertising system, transmitting advertisements to internet users based upon the categorization groups and the common traits and behaviors of the categorization groups.

In accordance with another embodiment of the present invention non-transitory computer readable media are provided, having stored there on, computer executable process steps operable to control a computer to perform the method described above.

In accordance with another embodiment of the present invention a system is provided which comprises a computer and memory. The memory contains data defining a plurality of assigned groups and further includes computer executable process steps. In this regard, it should be understood that the data defining the plurality of assigned groups can be input into the memory in any known manner. The computer is configured and arranged to execute the computer process steps to perform the steps of: receiving information sufficient to categorize a plurality of individuals into the plurality of assigned groups; receiving demographic, social, interest and behavioral information regarding the plurality of individuals; analyzing the demographic, social, interest and behavioral information about the individuals in each of the plurality of assigned groups, and for each assigned group, extracting from the demographic, social, interest, and behavioral information common traits and behaviors of the individuals in said each assigned group; and for each group, determining targeting metrics based on the common traits and behaviors identified for said each assigned group.

### BRIEF DESCRIPTION OF THE DRAWINGS

FIG. 1 is a high level system diagram of a system in accordance with an embodiment of the present invention.

FIG. 2 is an exemplary flow chart which can be implemented with the system of FIG. 1.

FIG. 3 is a more detailed system level diagram for an exemplary system in accordance with an embodiment of the present invention.

### DETAILED DESCRIPTION OF PREFERRED EMBODIMENTS OF THE INVENTION

In accordance with an embodiment of the present invention, social media or social networking information is used to automatically identify, for each of a plurality of assigned groups, common traits and behaviors of individuals in each group, and to use those common traits and behaviors to develop targeting metrics and/or to automatically categorize additional individuals into groups. As used herein, the terms “social media” and “social networking” are interchangeable.

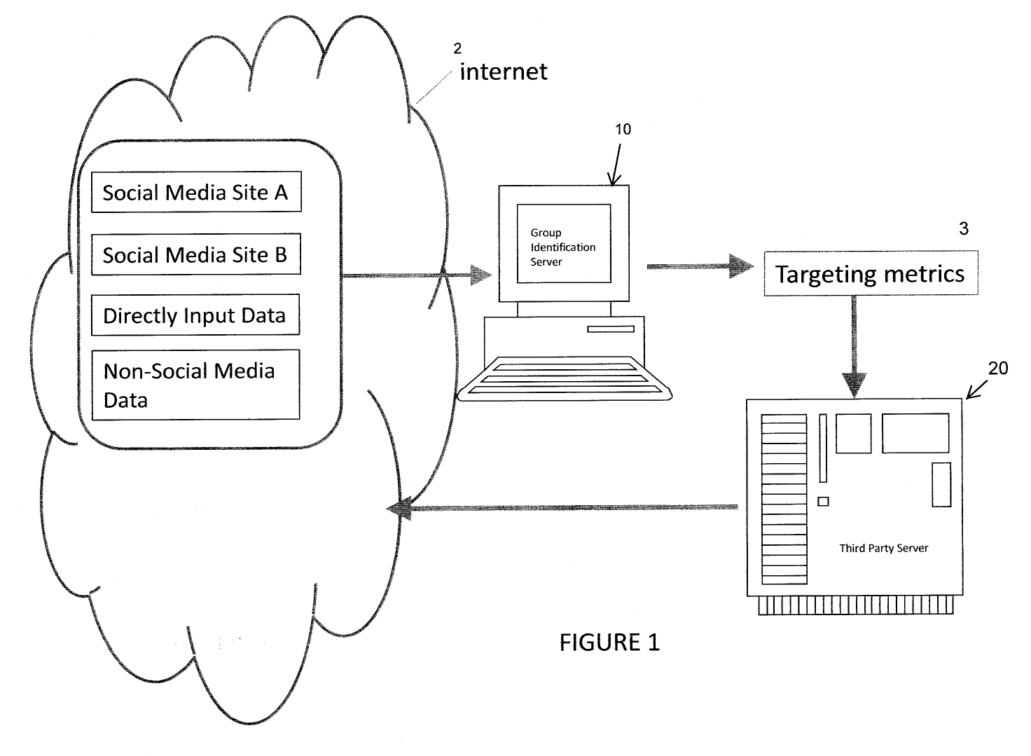

FIG. 1 shows a high level system diagram of an embodiment of the present invention. A group identification server 10 accesses information regarding individuals from various sources over the internet 2. The sources may include one or more social media websites, data input directly from the individuals, and non-social media data from third parties. The server 10 analyzes this information and, may, for example, generate targeting metrics 3 which are provided to a third party server 20 which, may in turn, generate targeted advertisements over the internet 2.

In particular, the systems and methods according to embodiments of the present invention preferably (i) categorize, manually or automatically, people into defined groups; (ii) analyze the demographic, social, interest and behavioral information about people in a known group, and extracting from this common traits and behaviors within that group; (iii) determine targeting metrics based on the common traits and behaviors identified for that group (iv) automatically categorizing newly encountered people into groups based on their known demographic, social, interest and behavioral information; (v) automatically track people's change in group affiliation over time; (vi) perform meta-analysis on and between differing groups; and (vii) automatically map social behaviors and groups into existing business- and domain-specific groups.

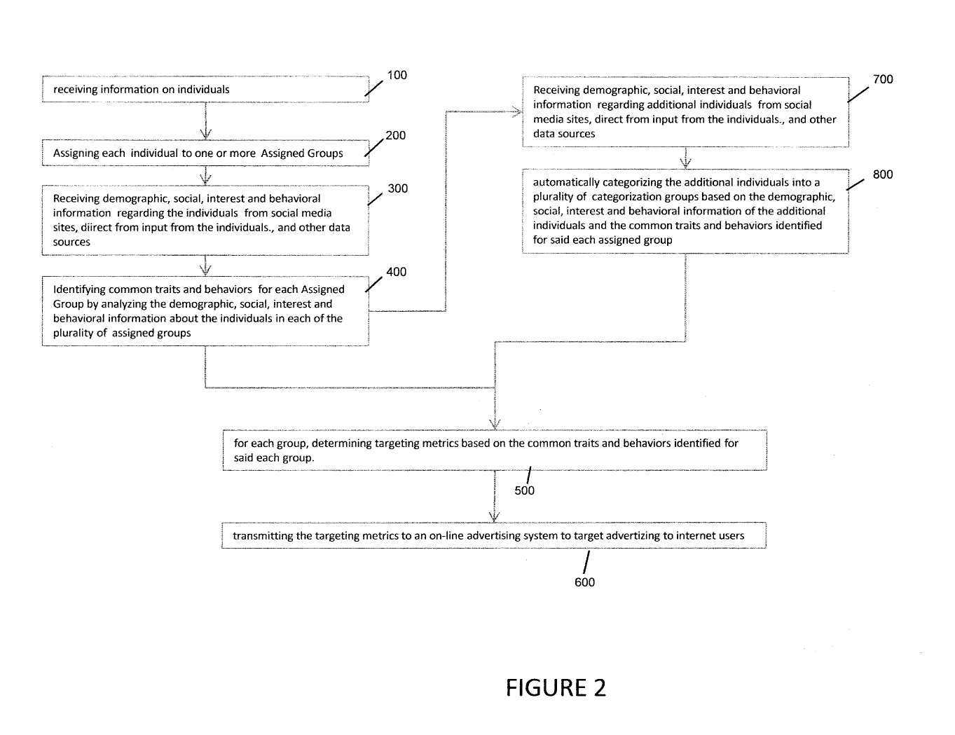

FIG. 2 illustrates a high level flow chart which can be used to implement embodiments of the present invention.

In a very simple hypothetical example of the use of an implementation of the invention, a business might have two different programs its customers can join: a “Gold Card” program and a “Discount Card” program. Accordingly, these customers are categorized into two defined groups: the Gold Card group and Discount Card group. Referring to FIG. 2, in this example, the business would receive information on its customers (step 100) as part of its application process and assign customers to one of two assigned groups (step 200): Gold Card group and Discount Card Group.

In accordance with an embodiment of the present invention the business would request access to those customers social media information (as is a standard feature of social media sites).

The group identification server 10 would then access this social media information (or be provided with it) (step 300), and analyze the data about the customers in each group and identify common traits and behaviors within each group (step 400). The server 10 would then determine targeting metrics based on the common traits and behaviors identified for the Gold Card and Discount Card Groups (step 500), and in step 600, transmit the targeting metrics 3 to the business (e.g. third party server 20).

This would allow the business to target advertising of the Gold Card at people similar to those already in the Gold card program, and thus more likely to be responsive to the advertising. The same could be done for the Discount card.

Additionally as the business connected with more customers, the implementation of the server 10 could automatically categorize customers as suitable for either the Gold Card, Discount Card, or neither based on the demographic, social interest and behavior received for those additional individuals and the common traits and behaviors of the Gold Card group and the Discount Card group (steps 700 and 800). This would both allow the business to offer the correct card to new customers, or treat them in a way appropriate to the card they are suitable for.

It should, however, be understood that the present invention is not in any way limited to membership cards, or anything else in this hypothetical example. Rather, this example illustrates what one business might be interested in analyzing using an implementation of the invention.

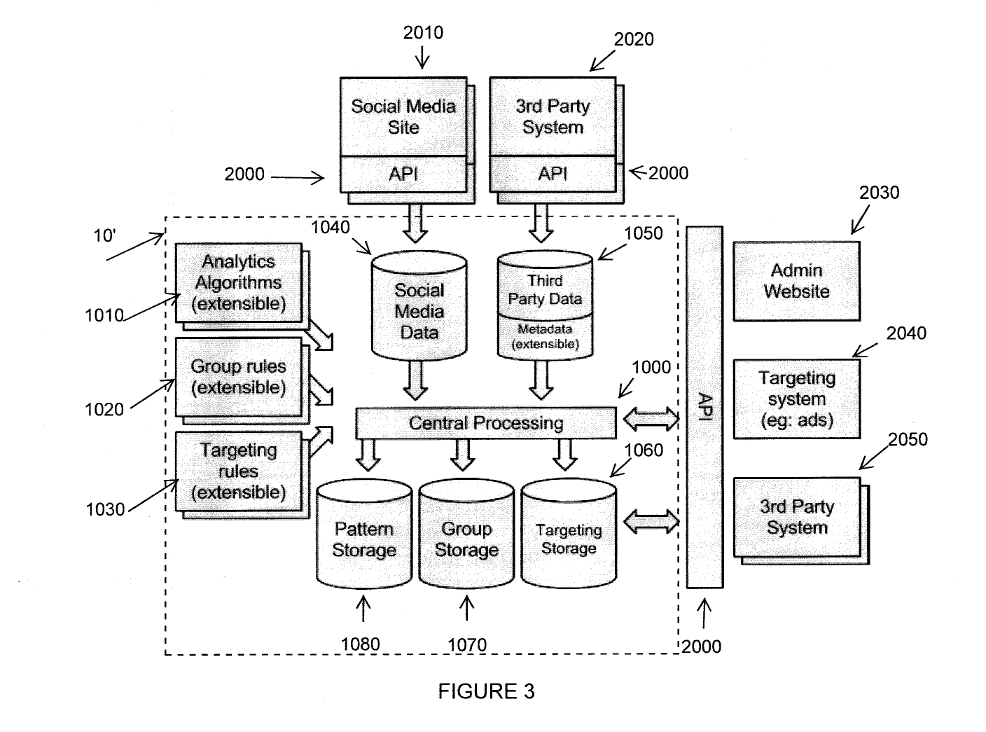

FIG. 3 provides a more detailed system diagram which can be used to implement embodiments of the present invention. In this regard, a server 10′ accesses data from social media sites 2010 and third party systems 2020 via application programming interfaces 2000 (APIs). The server 10¹ can also communicate with an admin website or portal 2030, an advertising targeting system 2040, and other third party systems 2050 via APIs 2000. Server 10¹ includes a processor 1000 which stores social media data received from the social media sites, third party data received from the third party data, as well as extensible meta data in memory 1040, 1050. As described below, server 10¹ includes extensible analytics algorithms 1010, group rules 1020, and targeting rules 1030 which are used by the processor 1000, as well as stored information regarding patterns, groups, and targeting metrics in memory 1080, 1070, and 1060.

The system and method according to the present invention takes as input information about people from social media sites. The details of how this happen are specific to each social media site, but generally requires the person to identify themselves and give permission for their data to be used. Data may also be input from other sources such as third party systems 2020, or direct entry through an administrative portal 2030.

The data gathered in this way differ depending on various factors. However, the data may include: (i) data provided by the social media site; (ii) data requested by the system according to the present invention for a particular person; (iii) data provided by the person; and (iv) granting of permissions for data by the person.

For example, social networking sites store information about people and their connections to other people, companies, products, events, and other real-world and virtual entities. This information is often referred to as the ‘social graph’. This information is made available to third parties so that users of social media sites can use their social identity on third party sites. Once users give their permission to a third party that user's information can be accessed by the third party over HTTP protocols.

Preferably, the system according to the present invention takes as input that information about people from social media sites. This data can be accessed directly by an implementation of the invention via the HTTP APIs, or via integration with existing CRM (Customer Relationship Management) systems that have previously gathered the social graph information.

Examples of data gathering include, but are not limited to: (i) gathering data on demographic information on the individual such as age, gender, hometown, etc.; (ii) gathering data on the individual's relationships with other people such as which other users of the social network the person is friends with, family to, in a relationship with, etc.; (iii) gathering data on items the individual has expressed interest in, for example, different social networks allow users to indicate an in interest or affiliation with products, famous people, art forms, films, etc.; (iv) gathering data on the individual's location check-ins, for example, many social media sites have check-in functions that allow users to indicate they are at a particular venue at a particular time; (v) gathering data on activities participated in by the individual such as watching of specific sports games, listening to named music tracks, entering of competitions, etc.

As illustrated in FIGS. 1 and 3, the system can also use data from non-social media sources. The system can use this additional data to map to the social data discussed above. For example transactional data about users can be included, so the invention can group users combining both social and transaction data. The system is extensible, and so any additional data can be mapped. This allows customer specific data to be included in the grouping. Additional data can include census data, credit score data, public records, data specifically provided by the user (for example, on a credit application). The additional data may also include data related to, and held by, the user. For example, a sports fitness company may have date on individuals fitness levels and work out routines. Further, although the data from the non-social media sources are illustrated in FIGS. 1 and 3 as transmitted to the server 10 over the internet, and this is in fact advantageous, it should be understood that the data from the non-social media sources can be provided to the server in any known manner, including, for example, by direct data entry through a keyboard, by transfer over a LAN, WAN, or via computer readable media such as disk drives or flash drives, among others.

As described above, in accordance with embodiments of the present invention, each of a plurality of individuals is assigned to one or more groups, referred to herein as Assigned Groups.

In this regard, the system takes as input grouping of the individuals that have had social data provided for them. These groups are called “assigned groups”. An individual may be a member of 0, 1 or more groups. The system simply needs to know which group or groups each individual is in. It does not need any semantic knowledge about what the group represents. In our example above, the system would take as input information which indicates, for each of a plurality of individuals, whether they are in the Gold Card Group, the Discount Card Group, or neither group. The system would not need to know, for example, that these groups relate to loyalty cards. If semantic information about groups is known, this can optionally be used to enhance automated use of group assignment.

Individuals can be assigned to a group either manually or automatically.

In the case of manual group assignment, manual input to the system can identify the individuals and their assigned groups. For example, the group assignment can be part of the third party data about users, or entered via an administrative website or portal. Individuals can also be assigned groups based on particular behavior on social media sites, or sites connected to social media sites. For example, individuals who have interacted with a particular brand on a social media site may be assigned to a group relating to that brand. As another example, an individual who influences their friends to make a social action might be assigned to a group called “influencers”. All of this can be entered manually.

Individuals can also be automatically assigned to groups by, for example, integrating the system with other third party on-line systems. In this regard, an extensible system of integration with other online services can be implemented which allows grouping based on both the source of the person giving data, and associated data that the source provides. For example, if the system is integrated with a particular online advertising system, when a person provides social data via an advertisement on that system, they can be automatically be classified into a group noting that they came from that advertising system. Additionally if the advertising network provides the keyword that attracted the person, that can be used as another automatic group. As another example, a user of the system may have their own data about people's purchase behavior in their business. Based on this data, people could be automatically classified into groups such as “frequent visitors” or “high spenders”.

As explained above with regard to FIG. 2, the system and method according to embodiments of the present invention further includes receiving demographic, social, interest, and behavioral information regarding the individuals in each Assigned Group and identifying common traits and behaviors for each Assigned Group.

Data about the individuals in a group is analyzed to ascertain the common traits and behaviors within that group. In this regard, the data analyzed may include both social media information from social media sites, as well as direct input from the individuals as well as other data described above. Common traits and behaviors can be identified through statistical analysis of the frequency of common attributes in the data appearing for that group. It should be understood that identifying commonalities within a group can be performed on all types of groups mention discussed herein, including Assigned Groups, Categorization Groups (see below), Moving Groups (see below), and Meta Groups (see below).

In accordance with other aspects of embodiments of the present invention, the system may be provided with metadata for known social data types, and the system can be configured to analyze the metadata in various ways. An extensible framework of metadata allows the system to be updated with new information about how to analyze data as more data types are identified, and existing metadata can be updated to improve the analysis over time. For example, users on Social Media sites can indicate a “liking” for individual films. Metadata can be provided to categorize these films into different types: horror, family, sports, etc. Analysis can then be performed on the metadata of film types in addition to specific films. For example, someone who indicates they like the film ‘Serenity’ can be inferred to like films of the type ‘Sci-Fi’ for the purposes of analysis. Initially the metadata could be provided manually by a company using the system, and later could be improved by automating the classifications from a third party data sources via API.

In accordance with still other aspects of embodiments of the present invention, the system can provide semantic analysis of external references. In this regard, in cases where the social data type refers to an external entity, or where external entities can be identified from social activity, those entities can be semantically analyzed for additional information. Techniques such as Latent Semantic Indexing (Deerwester, et al, 1988) can be used to identify patterns and similarities between textual content in external references. For example, a link posted to a social network can be followed and the content of the web page it links to and semantically analyzed to ascertain what its content refers to and if semantic analysis determines that the link referred to a page about a football match then this can be included with other sport interest information about that person.

In accordance with still other aspects of embodiments of the present invention, the system can provide pattern analysis for unknown data types. In this regard, for unknown social data types, the system can perform blind string and numeric analysis on the data to determine patterns. For example an implementation of the system may not have metadata about the data type “fnord”, but could identify that that members of a specific group were statistically more likely to have this value set to “23” than any other value. This analysis could be simple statistical analysis, using MapReduce systems, or stochastic and probabilistic variants of Latent Semantic Indexing.

As discussed above with regard to FIG. 2, the system and method may, for each group, determine targeting metrics based on the identified common traits and behaviors of the group. In this regard, an extensible series of modules, such as targeting rules modules 1030, can take the identified traits and behaviors and filter and process the identified commonalities and output information for use in specific domains. As the system is automated, these targeting metrics can be automatically fed into other online systems, including but to limited to online advertising systems. For example Online Advertising Keyword modules might identify advertising keywords that can be used to target online adverts at people similar to those in the initially identified group. Those keywords can then be automatically fed into online advertising systems.

As described above with regard to FIG. 2, the system and method in accordance with embodiments of the present invention may also receive demographic, social, interest, and behavioral information regarding additional individuals from social media sites, direct input from the individuals, and other data sources, and automatically categorize the additional individuals into a plurality of categorization groups based on the demographic, social, interest, and behavioral information of the additional individuals and the common traits and behaviors for each Assigned Group.

A more generic implementation of this categorization group feature is a new person categorization metric. In this regard, by knowing the traits associated with a group, a new person about whom social data is known can be analyzed for a match to a group or groups. This can be implemented using machine learning prediction systems. In addition to the raw social data about people, the common traits and behaviors for each group are used to significantly enhance the speed of learning and quality of classification. In this way people can be analyzed and given scores for their likely fit to each group. It should be understood, moreover, that categorizing people's fit to a group is not limited to the categorization groups described in steps 700 and 800 of FIG. 2, but can be applied all types of groups discussed herein, including Assigned Groups, Categorization Groups (see below), Moving Groups (see below), and Meta Groups (see below).

In accordance with still other aspects of embodiments of the present invention, the system can provide person categorization metrics. In this regard, an extensible series of modules filters and processes the new person categorization scores and output information for specific domains. For example a simple “Which group are they?” module would simply return the group the person was most likely associated with. As another example, a “Probably Crossover” module might return people who are more than likely members of more than one group within a given set.

As noted above, automatic group assignment to categorization groups (FIG. 2, steps 700 and 800) is a specific type of new person categorization metric. In this regard, for automatic group assignment to categorization groups, the system automatically assign people into groups based on the New Person Categorization. These groups are called Categorization Groups, and are distinct from Assigned Groups (although they may be related). For example, an input Assigned Group might be called “top supporters”. New people matching this group might be automatically put in the Categorized Group called “like a top supporter”.

People's interests and behaviors change over time. In accordance with further aspects of the present invention, the system and method can provide dynamic group categorization and generate moving groups. In this regard, in cases where social media sites (or 3rd party data sources) provide ongoing access to people's data, these data can be updated on a regular basis and reclassification of Categorization Groups performed to give an up-to-date analysis of groupings. Old data is retained, allowing analysis of previous traits and behaviors predicting movement. People moving between Categorization Groups can also be automatically classified into groups detailing their movement. These new groups are called Moving Groups. The system is extensible to allow complex movements to be tracked. Initially, the system may generate the following groups: (i) group of people who have moved groups; (ii) group of people who have moved from group X to group Y, where X and Y are any non-movement-groups within the system; (iii) group of people who have moved out of and then back into the same group.

In accordance with still other aspects of embodiments of the present invention, the system can provide Meta Groups. Meta groups are based on the intersection of other groups and can include all group types: Assigned Groups, Categorized Groups, Moving Groups and other Meta Groups. Meta groups use an extensible set of logical operators to create a group from the combination of other groups. Any number of groups can be used as a basis for a new meta group. For example, an initial set of logical operators may include: AND (people that are in all groups are part of the new group), OR (people who are in either group), NOT (people who are not in a specified group), and XOR (people who are in one of the groups, but not both). For example: a new meta group might be defined as containing the people who are in either group A or group B, but isn't in group C. In terms of the above referenced Boolean operations: New Meta Group=(Group A OR Group B) NOT Group C. Meta groups can be updated when the groups they are based on update. The updating can be automatic or manual.

In the preceding specification, the invention has been described with reference to specific exemplary embodiments and examples thereof. It will, however, be evident that various modifications and changes may be made thereto without departing from the broader spirit and scope of invention as set forth in the claims that follow. The specification and drawings are accordingly to be regarded in an illustrative manner rather than a restrictive sense.

What is claimed is:

1. A computerized method of providing targeting metrics, comprising, using a computer, performing the steps of:
providing a plurality of assigned groups;
receiving information sufficient to categorize a plurality of individuals into the plurality of assigned groups;
receiving demographic, social, interest and behavioral information regarding the plurality of individuals;
analyzing the demographic, social, interest and behavioral information about the individuals in each of the plurality of assigned groups, and for each assigned group, extracting from the demographic, social, interest, and behavioral information common traits and behaviors of the individuals in said each assigned group; and
for each group, determining targeting metrics based on the common traits and behaviors identified for said each assigned group.

2. The method of claim 1, further comprising, using a computer, preforming the steps of:
receiving demographic social, interest and behavioral information regarding a plurality of additional individuals;
automatically categorizing the additional individuals into a plurality of categorization groups based on the demographic, social, interest and behavioral information of the additional individuals and the common traits and behaviors identified for said each assigned group.

3. The method of claim 2, further comprising, using a computer, performing the steps of
receiving updated demographic social, interest and behavioral information regarding at least a subset of the plurality of additional individuals;
automatically re-categorizing the at least a subset of the additional individuals into the plurality of categorization groups based on the updated demographic, social, interest and behavioral information of the at least a subset of the additional individuals and the common traits and behaviors identified for said each assigned group, wherein said re-categorizing results in at least some of the subset of individuals changing categorization groups.

4. The method of claim 2, further comprising, using a computer, performing the steps of
for each of the additional individuals for which the step of re-categorization resulted in a change in categorization group, automatically categorizing said each additional individual into a movement group.

5. The method of claim 4, wherein there are a plurality of movement groups, and wherein each additional individual for which re-categorization resulted in a change in categorization group is categorized into at least one of the plurality of movement groups.

6. The method of claim 5, wherein the plurality of movement groups include a separate movement group for individuals who have moved from categorization group X to categorization group Y.

7. The method of claim 6, wherein the plurality of movement groups include a separate movement group for individuals who have moved from one categorization group to another categorization group.

8. The method of claim 6, wherein the plurality of movement groups include a separate movement group for individuals who have moved from one categorization group to another categorization group and back.

9. The method of claim 5, wherein the plurality of movement groups include a separate movement group for individuals who have moved from one categorization group to another categorization group.

10. The method of claim 5, wherein the plurality of movement groups include a separate movement group for individuals who have moved from one categorization group to another categorization group and back.

11. The method of claim 2, further comprising, using a computer, performing the step of generating a plurality of meta groups, each meta group being a combination of assigned groups, or a combination of categorization groups, or a combination of one or more assigned groups and one or more categorization groups.

12. The method of claim 1, further comprising transmitting the targeting metrics to an on-line advertising system.

13. The method of claim 12, further comprising, using the on-line advertising system, transmitting advertisements to internet users based upon the assigned groups and the common traits and behaviors of the assigned groups.

14. The method of claim 2, further comprising, using an on-line advertising system, transmitting advertisements to internet users based upon the assigned groups, the categorization groups, and the common traits and behaviors of the assigned groups, and the common traits and behaviors of the categorization groups.

15. The method of claim 2, further comprising, using an on-line advertising system, transmitting advertisements to internet users based upon the categorization groups and the common traits and behaviors of the categorization groups.

16. Non-transitory computer readable medium, having stored thereon, computer executable process steps operable to control a computer to perform the steps of
receiving a plurality of assigned groups;
receiving information sufficient to categorize a plurality of individuals into the plurality of assigned groups;
receiving demographic, social, interest and behavioral information regarding the plurality of individuals;
analyzing the demographic, social, interest and behavioral information about the individuals in each of the plurality of assigned groups, and for each assigned group, extracting from the demographic, social, interest, and behavioral information common traits and behaviors of the individuals in said each assigned group;
for each group, determining targeting metrics based on the common traits and behaviors identified for said each assigned group

17. A system, comprising,
memory containing data defining a plurality of assigned groups, said memory including computer executable process steps; and
a computer configured and arranged to execute the computer process steps to perform the steps of:
receiving information sufficient to categorize a plurality of individuals into the plurality of assigned groups;
receiving demographic, social, interest and behavioral information regarding the plurality of individuals;
analyzing the demographic, social, interest and behavioral information about the individuals in each of the plurality of assigned groups, and for each assigned group, extracting from the demographic, social, interest, and behavioral information common traits and behaviors of the individuals in said each assigned group;
for each group, determining targeting metrics based on the common traits and behaviors identified for said each assigned group
